(19) United States
(12) Patent Application Publication
(10) Pub. No.: US 2025/0278991 A1
(43) Pub. Date: Sep. 4, 2025

(54) Device to Provide Lighting and Noise Disturbances in an Active Shooter Environment

(71) Applicant: Mark Tarrance, Saint Johns, FL (US)

(72) Inventor: Mark Tarrance, Saint Johns, FL (US)

(21) Appl. No.: 18/593,315

(22) Filed: Mar. 1, 2024

(51) Int. Cl. G08B 7/06

(52) U.S. Cl. CPC G08B 7/06

(57) ABSTRACT

A device to provide lighting and noise disturbances in an active shooter environment is described that will alert both the occupants of the building, but also allow the image of the shooter to be captured and then hopefully isolate the shooter as quickly as possible. The device would also allow all exits and entrances of the building to be locked to prevent or restrict the movement of the shooter within the building, but at the same time allow the occupants of the building to flee the building.

### BACKGROUND OF THE INVENTION

### A. Field of the Invention

This relates to early detection of a possible gunshot incident involving any type of large building. This could include schools, churches, hospitals, gymnasiums, and warehouses. The purpose of this application is to be able to warn the occupants of a possible adverse incident involving a gunshot, as well as be able to isolate and/or capture the shooter and provide information for the occupants within the building and law enforcement personnel. This device could be retrofitted to any existing building or could be used as a separate stand-alone system that is incorporated into new construction.

### B. Prior Art

There are many other references to gunshot detection systems using videos and acoustic information. A representative example of this can be found Fowler, U.S. Pat. No. 10,586,109. This device detects a gunshot discharge based on infrared, as well as acoustic information. The device also will be used to perform the function of tracking a suspected shooter using the video that is collected.

Another reference can be found at Fowler, U.S. Pat. No. 11,282,353. This is a gunshot detection system using video analytics to classify the gun type that is being used. Another prior art reference can be found at Fowler, U.S. Pat. No. 10,657,800. According to the application, the firearm typically emits energy within the infrared spectrum and that energy is detected by the infrared sensor. A firearm emits an acoustic pressure wave when fired and the acoustic sensor detects the acoustic pressure wave. A strobe from a firearm occurring near the time of a gunshot can cause false gunshot detection and the sensors are used to determine whether a gunshot has occurred.

Another representative example in the prior art can be found in Connell, U.S. Pat. No. 11,361,838. This reference is a gunshot detection sensor incorporated into the building management devices. This sensor can be incorporated in light fixtures, smoke detectors, thermostats and exit signs, which are positioned throughout the building. A final reference can also be found in Gersten, U.S. Pat. No. 10,540,877. The Gersten references a danger monitoring system which is comprised of a microphone configured to continuously digitize environmental sound. The Gersten device is not necessarily limited to active shooter incidents, but does seek the transmission of data in the event of a dangerous event such as a gunshot incident.

### BRIEF SUMMARY OF THE INVENTION

When there is an adverse incident involving a gunshot, it is paramount to locate the shooter and neutralize the shooter or isolate the shooter. It is also imperative to provide information to the occupants of the building so that the occupants can either safely exit the building or seek appropriate shelter. Gunshots incidents occur with very little warning and immediate action is paramount.

In the event of the gunshot, software would detect the presence of a gunshot, which is typically detected by the acoustic wave that is created by the gun and/or infrared energy software. The software would detect when the gunshot is detected and the location of the gunshot.

The software would activate cameras to identify and locate the shooter, as well as enable the system to track the shooter. A plurality of cameras will be used for this purpose and while the specific type of camera is not being claimed, the camera should operate in any type of adverse condition such as limited or dim lighting. The cameras would be positioned throughout the building to best capture the images of the shooter.

Lighting would also be activated by the software. The purpose of the lighting is to illuminate the area as much as possible, but also create a distraction for the active shooter. This lighting system in combination with the software will also provide information to the occupants to designate areas of safe passage.

In addition to the cameras and lighting, the software would also provide an alarm notification to the local authorities, as well as to the other occupants inside the building. The alarm would be loud and constant enough to distract the shooter and provide precious moments for the occupants of the building.

Mechanical locking devices will also be incorporated into the device, which would be activated by the software. The mechanical lockdown would isolate the shooter and/or isolate certain occupants of the building to prevent future harm.

### BRIEF DESCRIPTION OF THE DRAWINGS

FIG. 1 is a depiction of the schematic components of the device.

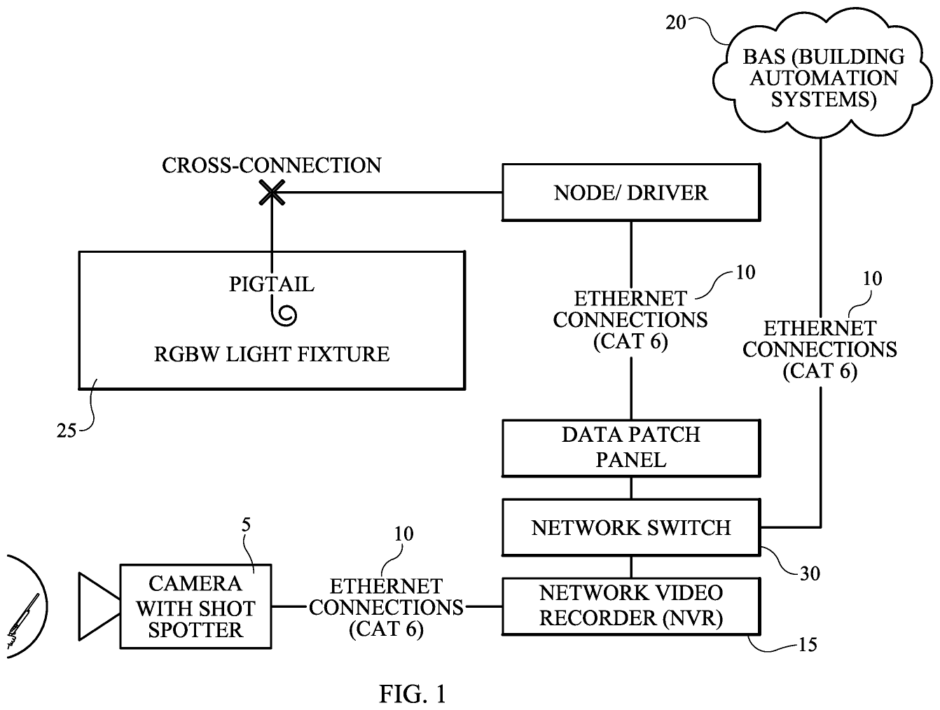

FIG. 2 is an illustration of the in-use view of this application depicting the shooter outside the building before the gunshot incident.

FIG. 3 is an illustration of the in-use view of the shooter moving within the building.

FIG. 4 is an illustration of the in-use view of the shooter in the hallways of a building depicting the floor lighting.

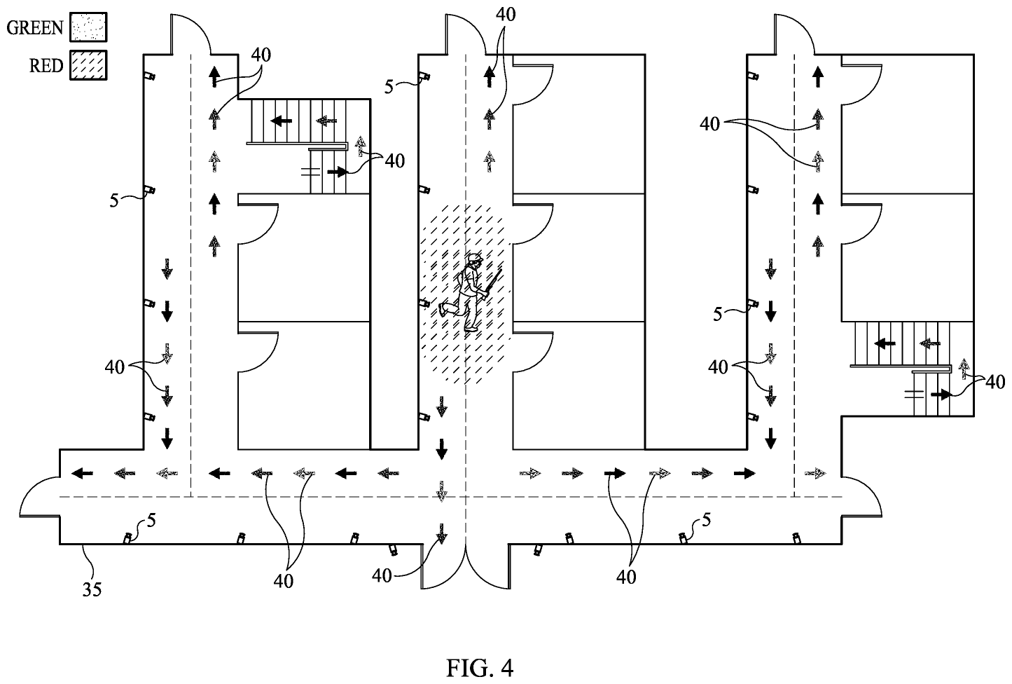

FIG. 5 is an illustration of the in-use view of the interior of the building depicting a fire within the building and a depiction of the interior floor lighting.

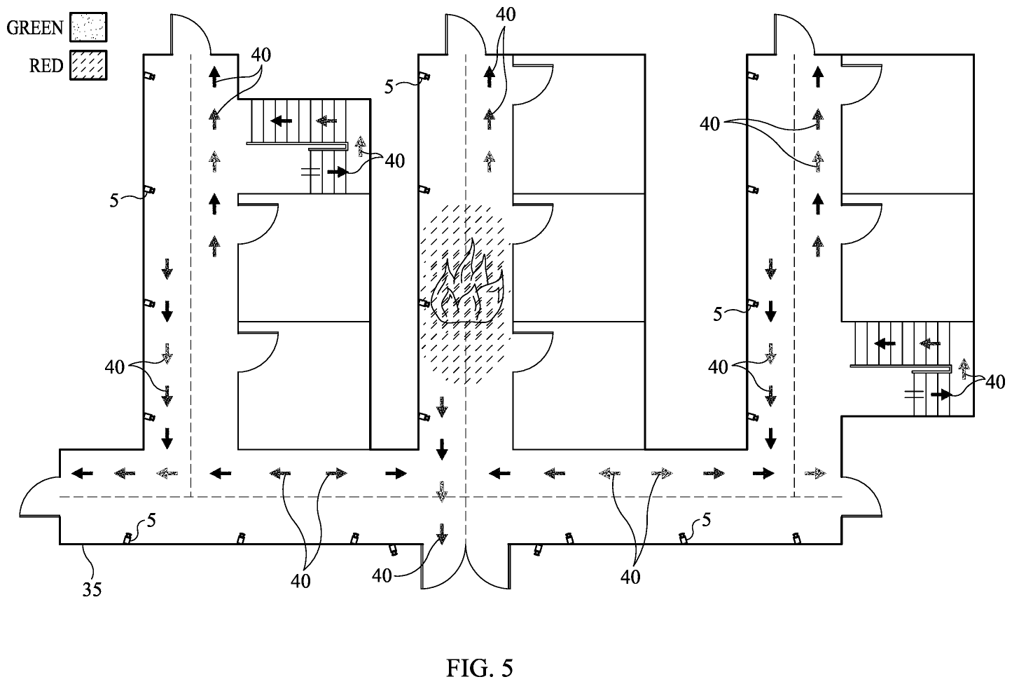

FIG. 6 is a depiction of the components of the system.

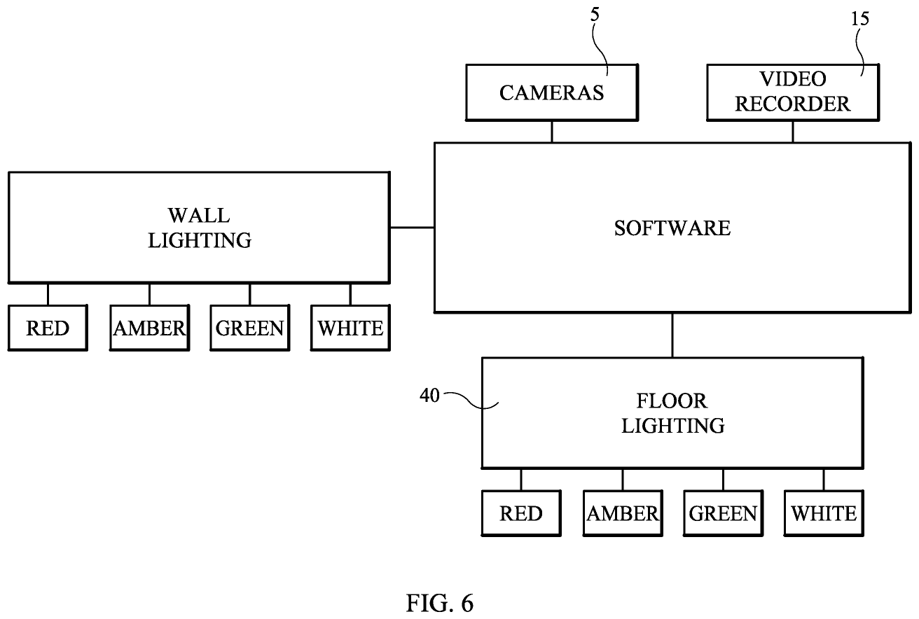

### NUMBERING REFERENCE

5—Cameras
10—Ethernet Connections
15—Video Recording
20—Building Automation Systems
25—Wall Lighting
26—Red Lighting
27—Amber Lighting
28—Green Lighting
29—White Lighting
30—Network Switch
35—Building
40—Floor Lighting
45—Software
50—Alarm Notification

### DETAILED DESCRIPTION OF THE EMBODIMENTS

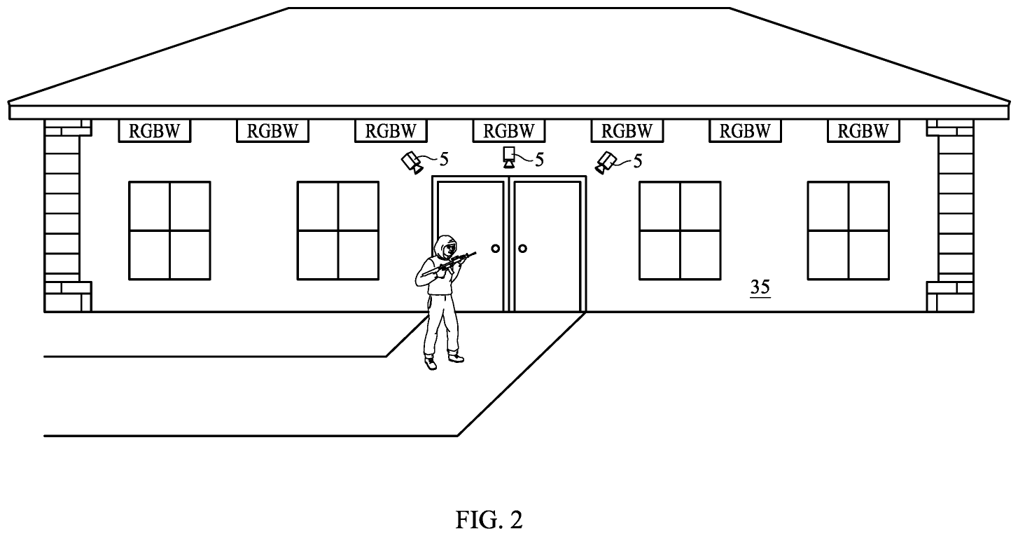

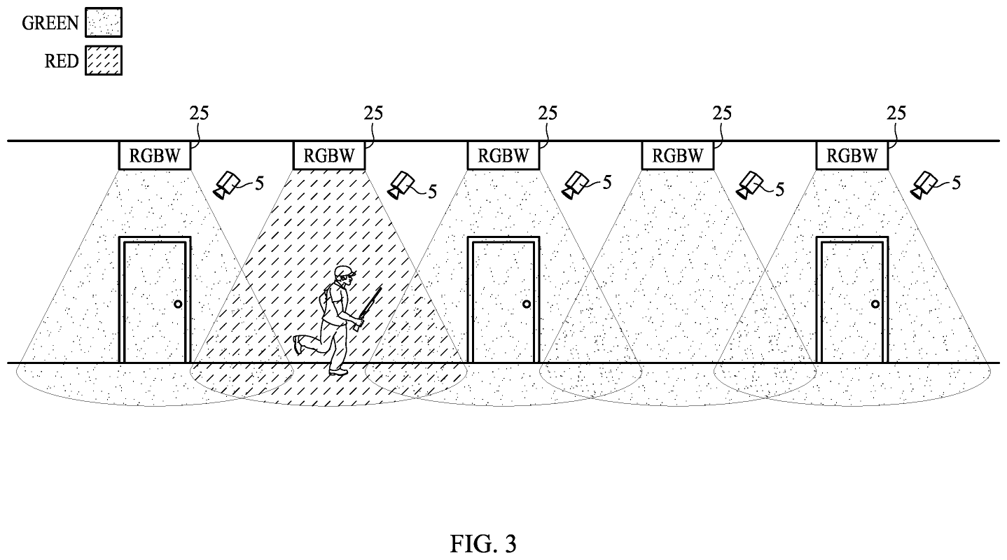

In the event of a gunshot incident, it is important to quickly identify the shooter, as well as provide information to any occupants within the building 35. Software, 45, would be incorporated into the system, which would control both the cameras, 5, and lighting, 25. The cameras would be positioned throughout the facility both on the outside of the facility and the interior of the facility to capture as many images of the shooter as possible such as depicted in FIGS. 2 and 3.

The cameras 5 may be line-scan or area cameras depending on a particular facility and the needs of a building owner. A video-recorder 15 would also be provided to store the captured images and provide video capability of the captured images. Software 45 would allow the transmission of the video recording to locations throughout the building as well as remote facilities such as law enforcement buildings.

Once the cameras 5 are activated, the video recorder, 15, and lighting 25 would be activated by the software 45. The lighting 25 is intended to be bright, and preferably to quickly illuminate the area. LED lighting is likely to be preferred because of the capability to quickly illuminate a space. Additionally, the lighting would be wired such that if the disabling of a single camera or a single light would not disable all cameras, and would not disable all the lighting. A video recorder 45 would capture needed information to identify the shooter and track the shooter. The information from the video recorder can be transmitted to a remote facility and can be stored for forensic purposes.

The lighting may include a strobe effect to further distract the shooter.

The software 45 would control the color of the lighting 5 to warn or educate the occupants of the building. Common lighting colors would be displayed and would educate the occupants of the building to include red 26 (unsafe passage), amber 27 (use caution) and green 28 (safe passage). White 29 lighting may be used to indicate that the system has not detected a gunshot incident. The operation of the lighting May also be controlled remotely.

Software 45 including network switches 30 and ethernet cables 10 link the components of the system and the operation of the components.

Once an incident occurs, an alarm notification, 50, would notify local authorities, as well as other occupants of the building. The alarm notifications may be audible or silent, depending on the needs or preferences of the user. If the alarm is audible, the volume level of the alarm should be sufficient to distract the shooter.

When an incident occurs, it is important to isolate the shooter as quickly as possible and alert other occupants. Floor lighting 40 which has been placed on the hallways of the floor would activate to provide information to the other occupants; this information would provide information about the possible whereabouts of the shooter within the building. The floor lighting would use the same color scheme (red, amber, green) as the general warning system to educate the occupants of the building.

The software 45 would link mechanical or electrical locks, 20, which would lock down or isolate a portion of the building as quickly as possible. The mechanical or electrical locks would operate automatically depending on pre-determined pre-sets of the software. This would help to isolate the shooter, as well as remove isolate occupants from harm.

While the embodiments of the invention have been disclosed, certain modifications may be made by those skilled in the art to modify the invention without departing from the spirit of the invention.

The inventor claims:

1. A device to provide lighting and noise disturbances in an
active shooter environment, which is comprised of a plurality of cameras,
wherein the plurality of cameras are positioned within the building,
lighting,
wherein lighting is placed on the floors of the facility,
wherein lighting is placed on the walls of the facility,
wherein different color lighting is provided, alarm,
locks,
software,
wherein software controls the lighting,
wherein software controls the alarm,
wherein software controls the plurality of cameras,
ethernet cables,
network switches,
video recorder.

2. The device to provide lighting and noise disturbances in an active shooter environment as described in claim 1 wherein green lighting is used.

3. The device to provide lighting and noise disturbances in an active shooter environment as described in claim 1 wherein amber lighting is used.

4. The device to provide lighting and noise disturbances in an active shooter environment as described in claim 1 wherein red lighting is used.

5. The device to provide lighting and noise disturbances in an active shooter environment as described in claim 1 wherein software controls mechanical locks.

6. The device to provide lighting and noise disturbances in an active shooter environment as described in claim 1 wherein software controls electrical locks.
